(19) United States
(12) Patent Application Publication
(10) Pub. No.: US 2006/0184830 A1
(43) Pub. Date: Aug. 17, 2006

(54) Disk device and disk processing method

(76) Inventors: Atsushi Takeda, Yokohama-Shi (JP); Tatsuji Ashitani, Yokohama-Shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/344,945

(22) Filed: Jan. 31, 2006

(30) Foreign Application Priority Data
Jan. 31, 2005 (JP) 2005-024577

(51) Int. Cl. G06F 11/00

(52) U.S. Cl. 714/42

(57) ABSTRACT

A disk device has a reading portion that reads out from a disk having a rewritable area, a plurality of defect management areas and a plurality of position information areas indicating an optimum position used for reproduction in the plurality of the defect management areas, a recording portion that records information in the rewritable area or the defect management area, a reproducing portion which reproduces information read out by the reading portion and stored in the rewritable area based on given defect management information, and a control portion that reads out a plurality of defect management information based on the plurality of the position information stored in the position information area and controls the reading portion and the recording portion so as to repair defect management information which fails to be read out corresponding to defect management information which is read out successfully.

### CROSS-REFERENCE TO RELATED APPLICATIONS

This application is based upon and claims the benefit of priority from prior Japanese Patent Application No. 2005-024577, filed Jan. 31, 2005, the entire contents of which are incorporated herein by reference.

### BACKGROUND

1. Field

The present invention relates to a disk device and disk processing method for reproducing an information recording medium having a defect management area which stores defect management area (DMA) information and more particularly to a disk device and disk processing method which if part of the defect management information is destroyed, automatically repairs this defect management information regardless of a host controller.

2. Description of the Related Art

Information memory medium such as an optical disk includes a user area for storing user data, which repairs defect generated in this user area. Such a procedure is called alternation processing. Area for managing information relating to the alternation processing, namely, defect management information is called defect management area (DMA).

Although of the information recording mediums, the DVD-RAM can be overwritten more than 100,000 times, a disk having a low recording resistance like HD DVD-RW has a plurality of the DMAs so as to possess a function for moving the DMA itself.

According to the patent document 1 (Jpn. Pat. Appln. KOKAI Publication No. 7-29177), DMA manager is not written into the DMA immediately but first written into a first DMA area and after that, when the DMA information is read and determined to be normal, that DMA information is written into remaining second to fourth DMAs so as to raise the reliability of the DMA information.

However, according to the conventional technology of the patent document 1, when new DMA information is recorded, write reliability is raised by confirming the information each time it is written into each area of a plurality of the areas. However, if part of the defect management information (hereinafter referred to as DMA) is lost due to damage, stain or the like in the recording area of the disk, this DMA is never automatically repaired. Therefore, there is such a problem that the reliability of the DMA cannot be maintained for a long term.

### BRIEF SUMMARY OF THE INVENTION

According to one embodiment of the present invention, there is provided a disk device comprising: a reading portion which reads out from a disk having a rewritable area, a plurality of defect management areas and a plurality of position information areas indicating an optimum position used for reproduction in the plurality of the defect management areas; a recording portion which records information in the rewritable area or the defect management area; a reproducing portion which reproduces information read out by the reading portion and stored in the rewritable area based on given defect management information; and a control portion which reads out a plurality of defect management information based on the plurality of the position information stored in the position information area and controls the reading portion and the recording portion so as to repair defect management information which fails to be read out corresponding to defect management information which is read out successfully.

### BRIEF DESCRIPTION OF THE SEVERAL VIEWS OF THE DRAWINGS

FIG. 1 is a diagram showing an example of the schematic structure of an information recording/reproducing apparatus according to an embodiment of the present invention;

FIG. 2 is an appearance diagram showing an example of a recording medium handled by the information recording/reproducing apparatus according to the embodiment of the present invention;

FIG. 3 is an explanatory diagram showing an example of arrangement of the DMA on a DVD-RAM handled by the information recording/reproducing apparatus according to the embodiment of the present invention;

FIG. 4 is an explanatory diagram showing another example of arrangement of the DMA on a DVD-RAM handled by the information recording/reproducing apparatus according to the embodiment of the present invention;

FIG. 5 is a flow chart showing an example of startup processing of the information recording/reproducing apparatus according to the embodiment of the present invention;

FIG. 6 is a flow chart showing an example of insertion processing of the information recording/reproducing apparatus according to the embodiment of the present invention;

FIG. 7 is a flow chart showing an example of idle processing of the information recording/reproducing apparatus according to the embodiment of the present invention;

FIG. 8 is a flow chart showing an example of discharge processing of the information recording/reproducing apparatus according to the embodiment of the present invention;

FIG. 9 is a flow chart showing an example of repair processing of the information recording/reproducing apparatus according to the embodiment of the present invention; and

FIG. 10 is a flow chart showing an example of alternation processing of the information recording/reproducing apparatus according to the embodiment of the present invention.

### DETAILED DESCRIPTION

Hereinafter embodiments of the present invention will be described in detail with reference to the accompanying drawings.

An information recording/reproducing apparatus of an embodiment of the present invention carries out alternation processing to a recording medium (optical disk) based on defect management information. Thus, this apparatus reads a plurality of pieces of defect management area information (hereinafter referred to as DMA) appropriately and if it finds out a DMA which cannot be read out partially, it automatically repairs this defect.

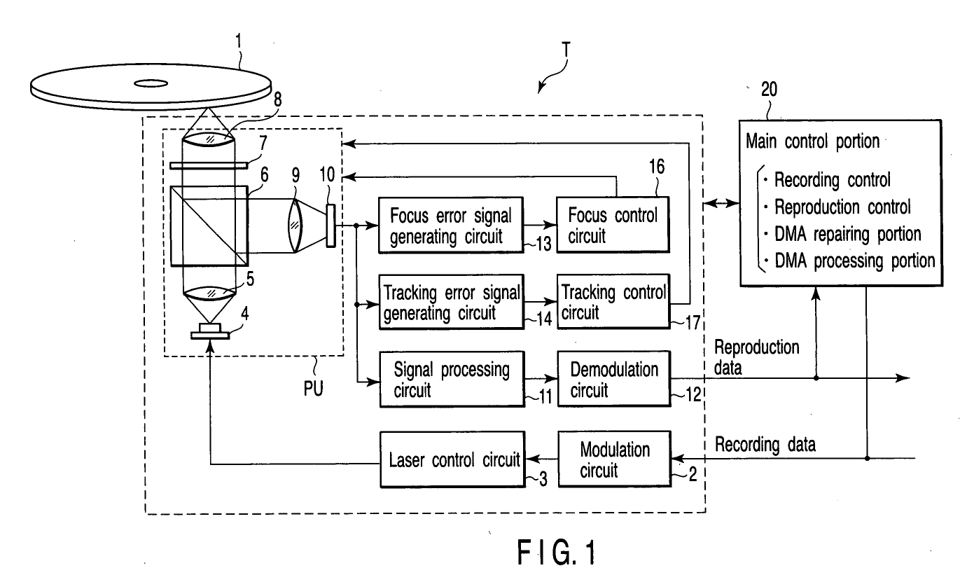

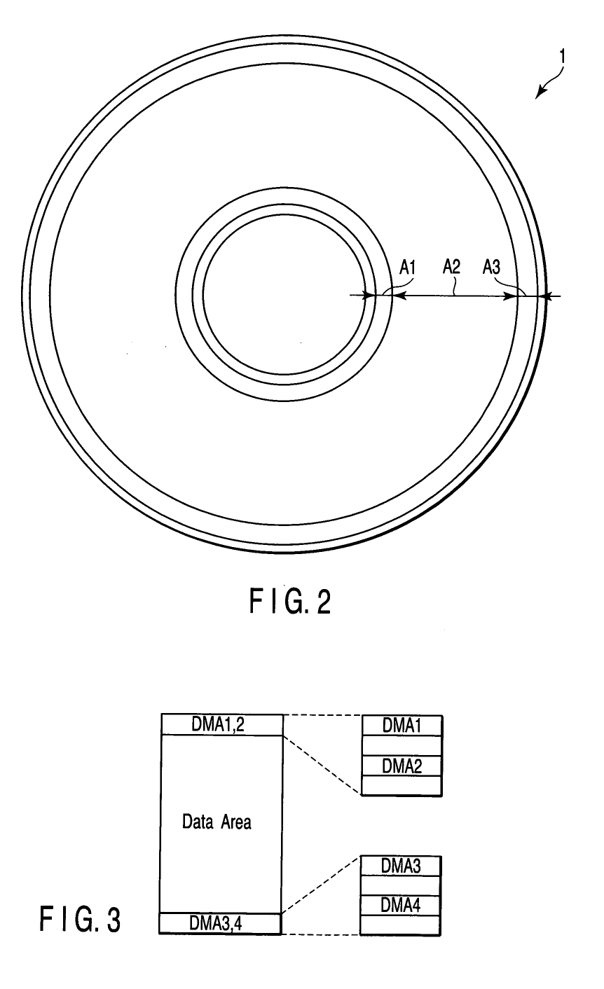

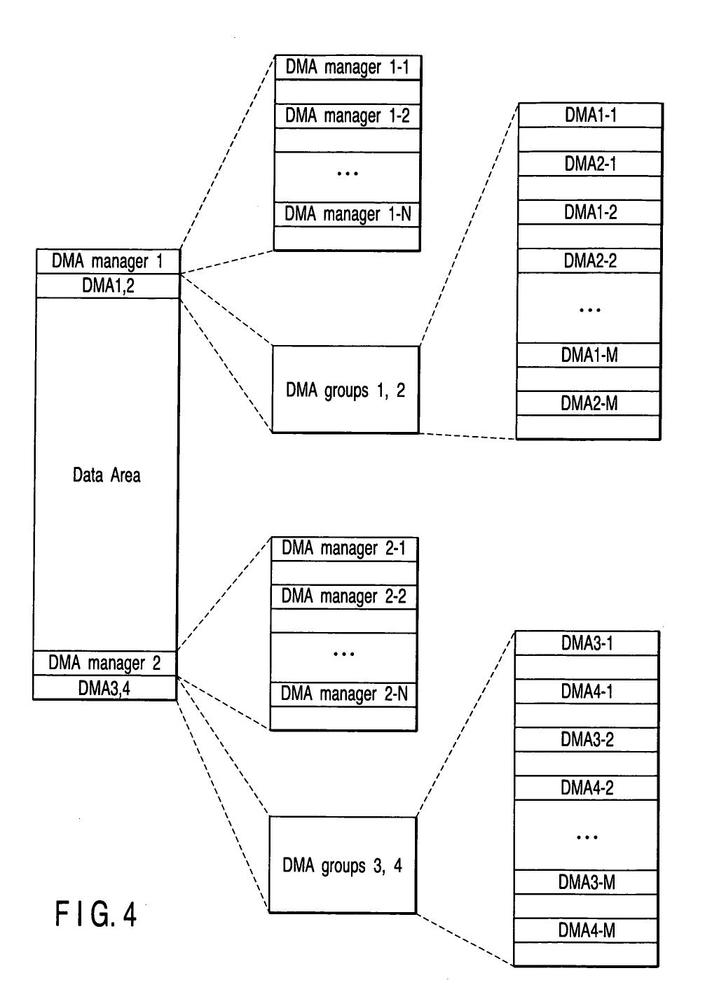

FIG. 1 is a diagram showing an example of the schematic structure of an information recording/reproducing apparatus according to an embodiment of the present invention. FIG. 2 is an appearance diagram showing an example of a recording medium handled by the information recording/reproducing apparatus according to an embodiment of the present invention. FIG. 3 is an explanatory diagram showing an example of arrangement of the DMA on a DVD-RAM handled by the information recording/reproducing apparatus according to the embodiment of the present invention. FIG. 4 is an explanatory diagram showing another example of arrangement of the DMA on a DVD-RAM handled by the information recording/reproducing apparatus according to the embodiment of the present invention.

<Example of Information Recording/Reproducing Apparatus of the Present Invention>

(Structure)

First, an example of the structure of the information recording/reproducing apparatus according to an embodiment of the present invention will be described in detail with reference to the accompanying drawings. FIG. 1 is a diagram showing an example of the schematic structure of an information recording/reproducing apparatus T according to an embodiment of the present invention. This information recording/reproducing apparatus 1 records user data in a medium (optical disk) 1 and reproduces user data recorded in the medium 1. This information recording/reproducing apparatus executes alternation processing as required.

As shown in FIG. 1, the information recording/reproducing apparatus T has a modulation circuit 2, a laser control circuit 3, and an optical pickup PU connected thereto. Here, the optical pickup PU has laser 4, a collimator lens 5, a polarized beam splitter (hereinafter referred to as PBS) 6, a ¼ wavelength plate 7, an objective lens 8, a condenser lens 9 and a light detector 10. Further, the information recording/reproducing apparatus T includes a signal processing circuit 11, a demodulation circuit 12, a focus error signal generating circuit 13, a tracking error signal generating circuit 14, a focus control circuit 16, a tracking control circuit 17 and a main control portion 20.

The main control portion 20 controls a drive portion for recording processing control, reproduction processing control and DMA processing and includes a DMA repairing portion which is an embodiment of the present invention. Here, the drive portion includes the modulation circuit 2, the laser control circuit 3, the laser 4, the collimator lens 5, the polarized beam splitter (hereinafter referred to as PBS) 6, the ¼ wavelength plate 7, the objective lens 8, the condenser lens 9, the light detector 10, the signal processing circuit 11, the demodulation circuit 12, the focus error signal generating circuit 13, the tracking error signal generating circuit 14, the focus control circuit 16, and the tracking control circuit 17.

(Operation)

Here, the processing operation of the information recording/reproducing apparatus T according to the embodiment of the present invention will be described. First, the recording processing of this information recording/reproducing apparatus T will be described. The recording processing of data is controlled by the main control portion 20. Recording data (data symbol) is modulated to a predetermined channel bit series by the modulation circuit 2. The channel bit series corresponding to the recording data is converted to laser driving wavelength by the laser control circuit 3. The laser control circuit 3 pulse-drives the laser 4 so as to record data corresponding to a predetermined bit series on the medium 1. Light beam for recording projected from the laser 4 are turned to parallel light by the collimator lens 5 and enters and passes through the PBS 6. The beam passing through the PBS 6 passes through the ¼ wavelength plate 7 and is focused on an information recording plane of the medium 1 by the objective lens 8. The focused beam is maintained in a state in which an optimum fine spot is obtained on the recording plane by focus control by the focus control circuit 16 and tracking control by the tracking control circuit 17.

Subsequently, data reproduction processing of this information recording/reproducing apparatus will be described. Reproduction of data is controlled by the main control portion 20. The laser 4 projects light beam for reproduction based on data reproduction instruction from the main control portion 20. The reproduction light beam irradiated from the laser 4 is turned to parallel light by the collimator lens 5 and enters and passes through the PBS 6. The light beam passing through the PBS 6 passes through the ¼ wavelength plate 7 and is focused on the information recording plane by the objective lens 8. The focused beam is maintained in a state in which an optimum fine spot is obtained on the recording plane by focus control by the focus control circuit 16 and tracking control by the tracking control circuit 17. At this time, the light beam for reproduction projected to the medium 1 is reflected by a reflecting film or a reflective recording film in the information recording plane. The reflected light passes through the objective lens 8 in an opposite direction and turns to parallel light again. The reflected light passes through the ¼ wavelength plate 7 so that it is provided with polarization of light perpendicular to incident light and reflected by the PBS 6. The beam reflected by the PBS 6 turns to converged light by the condenser lens 9, entering the light detector 10. The light detector 10 is constituted of, for example, a 4-division photo detector. Light beam entering the light detector 10 is converted photoelectrically to electric signal, which is amplified. The amplified signal is equalized by the signal processing circuit 11 to binary signal, which is sent to the demodulation circuit 12. The binary signal is subjected to demodulation corresponding to the predetermined modulation system by the demodulation circuit 12 and then reproduction data is outputted.

Further, a focus error signal is generated by the focus error signal generating circuit 13 based on part of the electric signals outputted from the light detector 10. Likewise, a tracking error signal is generated by the tracking error signal generating circuit 14 based on part of the electric signals outputted from the light detector 10. The focus control circuit 16 controls focus of beam spot based on the focus error signal. The tracking control circuit 17 controls the tracking of the beam spot based on the tracking error signal.

Here, the alternation processing, which is DMA processing by the main control portion 20, will be described briefly. Certification is carried out when a medium is formatted. At this time, the main control portion 20 detects a defect on the medium. A defect detected at this time, namely, defect management information relating to initial defect is recorded in PDL in the DMA of the medium by the main control portion 20. The defect management information includes an address of an alternation object sector and an address of an alternation destination sector. At normal recording time, the main control portion 20 detects a defect on the medium. A defect detected at this time, namely, defect management information relating to secondary defect is recorded in SDL in the DMA of the medium by the main control portion 20. The defect management information includes an address of a head sector of an alternation object ECC block and an address of a head sector of an alternation destination ECC block. An access to the alternation object is regarded as an access to the alternation destination based on PDL and SDL.

(DMA Manager on Recording Medium and DMA)

An example of the recording medium 1 handled by the information recording/reproducing apparatus T according to an embodiment of the present invention includes a lead-in area A1 on its innermost periphery and a lead-out area A3 on its outermost periphery. The medium 1 has a data area A2 between the lead-in area A1 and the lead-out area A3. The data area A2 has a user area UA and a spare area SA.

As shown in FIG. 3, the lead-in area A1 on the innermost periphery has first DMA series (DMA series 1, 2) and the lead-out area A3 on the outermost periphery has second DMA series (DMA series 3, 4). As shown in FIG. 4, the lead-in area A1 includes DMA manager 1-1 to 1-N, DMA1-1 to DMA1-M, DMA2-1 to DMA2-M and the lead-out area A3 includes DMA manager 2-1 to 2-N, DMA3-1 to DMA3-M, DMA4-1 to DMA4-M.

By disposing the DMA series on the innermost and outermost peripheries, a plurality of the DMA series are disposed physically apart from each other. As a result, the DMA becomes highly resistant to any defect.

<DMA Repair Processing Method of information Recording/Reproducing Apparatus of the Present Invention>

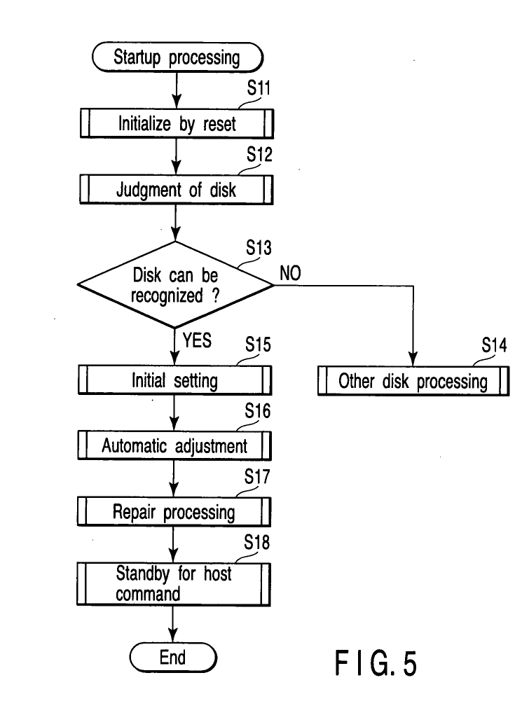

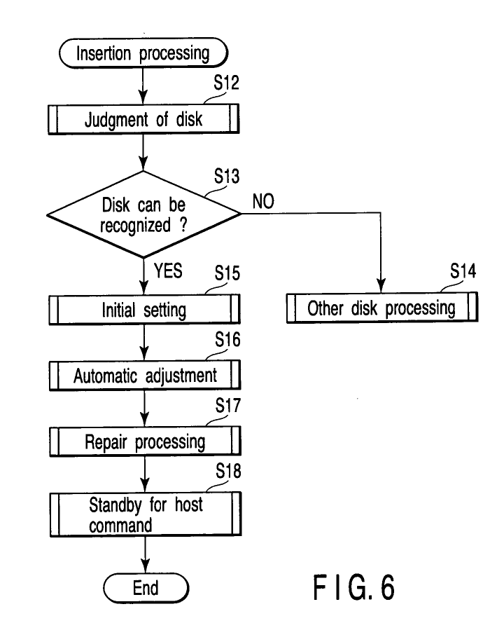

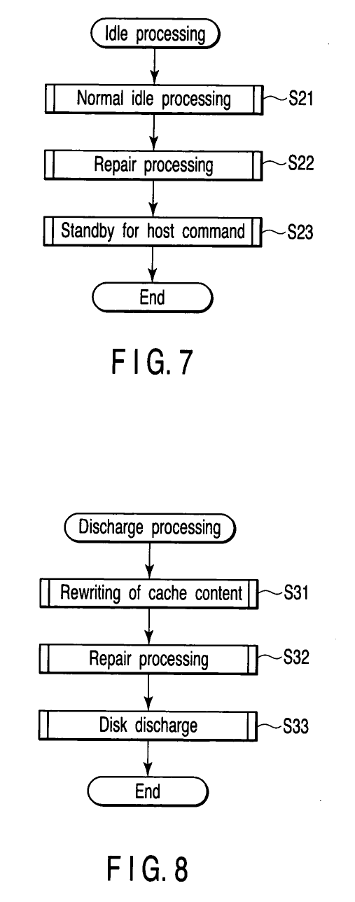

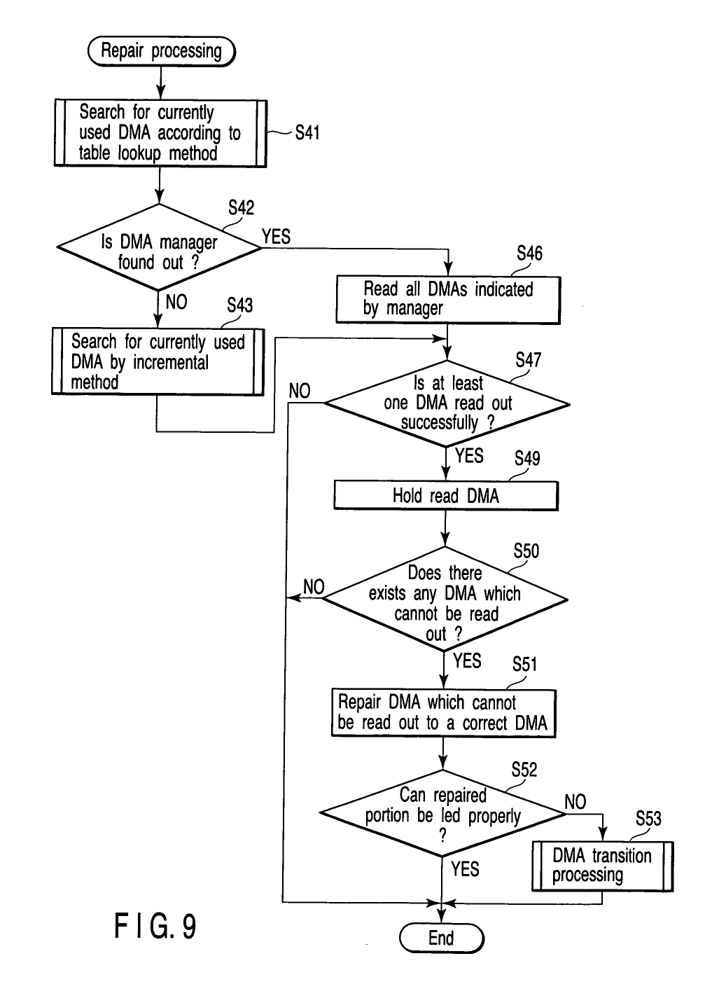

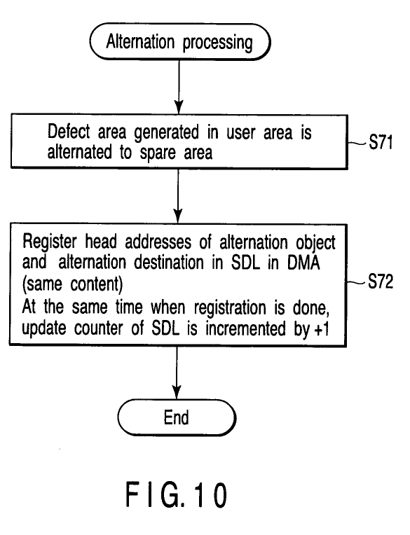

Next, the DMA repair processing method according to an embodiment of the present invention will be described in detail using a flow chart. FIG. 5 is a flow chart showing an example of startup processing of the information recording/reproducing apparatus according to the embodiment of the present invention. FIG. 6 is a flow chart showing an example of insertion processing of the information recording/reproducing apparatus according to the embodiment of the present invention. FIG. 7 is a flow chart showing an example of idle processing of the same apparatus. FIG. 8 is a flow chart showing an example of discharge processing of the same apparatus. FIG. 9 is a flow chart showing an example of repair processing of the same apparatus. FIG. 10 is a flow chart showing an example of alternation processing of the same apparatus.

In the information recording/reproducing apparatus according to an embodiment of the present invention, the DMA repair processing is automatically carried out without any user's operation (or may be carried out corresponding to user's forced operation), and for example, is carried out at a variety of timings shown in FIGS. 5 to 8.

That is, according to the flow chart shown in FIG. 5, in the information recording/reproducing apparatus, after the information recording/reproducing apparatus is started, the DMA repair processing is automatically carried out under the control of the control portion 20. Namely, upon startup of the information recording/reproducing apparatus, initialization is carried out by reset (S11) and a disk is judged (S12). If the disk can be recognized (S13), after the initial setting is carried out (S15), automatic adjustment is carried out (S16). After that, the DMA repair processing (S17) described later is carried out even if any operation by user is not executed. If the disk cannot be recognized immediately, other disk processing is executed (S14). After that, standby state is kept until host command is given (S18). Once a user inserts a disk, the DMA is automatically repaired until standby state for an operation command is generated. Thus, according to the above-described steps, even if any DMA block incapable of being reproduced due to drop in recording quality exists, the frequency of DMA transitions is suppressed by rewriting the DMA, so that improvements in recording service life and reliability can be expected.

According to the flow chart shown in FIG. 6, in the information recording/reproducing apparatus, when a disk is inserted into the reading portion, the DMA repair processing is automatically carried out. That is, if a disk is inserted into the reading portion of the information recording/reproducing apparatus, the disk is judged (S12). If the disk can be recognized (S13), after the initial setting is carried out (S15), automatic adjustment is executed (S16). After that, the DMA repair processing (S17) described later is carried out even if any user's operation is executed. If the disk cannot be recognized, other disk processing is carried out (S14). After that, the standby state is kept until a host command is given (S18).

According to the flow chart of FIG. 7, in the information recording/reproducing apparatus, the DMA repair processing described later is carried out (S22) when normal idle state arises (S21). After that, the standby state is kept until a host command is dispatched (S23).

According to the flow chart of FIG. 8, in the information recording/reproducing apparatus, the DMA repair processing is automatically carried out when a disk is discharged from the reading portion. That is, when the disk is discharged from the reading portion of the information recording/reproducing apparatus, the content of cache is rewritten (S31) and the DMA repair processing is carried out (S32). After that, the disk is discharged (S33).

DMA Repair Processing

The DMA repair processing will be described in detail using the flow chart shown in FIG. 9. When the DMA repair processing is started in each operation shown in FIGS. 5 to 8 under the control of the control portion 20 in the information recording/reproducing apparatus, a currently used DMA is searched according to table lookup system (S41). More specifically, a DMA manager is retrieved from the DMA managers 1-1 to 1-N or DMA manager 2-1 to 2-N as shown in FIGS. 2 to 4 and if it is found out (S41), all DMAs indicated by the manager are read out successively (S46). If the disk is HD DVD and formatted according to ARW format, the DMA repair processing is carried out for two manager areas and four pairs of the DMAs. If any manager is not found out in step S42, areas of DMA1-1 to DMA2-M or DMA3-1 to DMA4-M, which are the DMA areas indicated in FIGS. 2 to 4, are automatically read out without referring to information of the DMA manager by incremental system (S43).

If at least one of such read out DMAs can be read (S47), the read DMA is stored in a memory area or the like (S49). If any DMA which cannot be read out exists (S50), the DMA which cannot be read out is repaired to a correct DMA by writing into the area of the DMA which cannot be read out based on the information of the read out DMA (S51). Here, the DMA at a repaired portion is read out again and if there is no problem in the read out content, the procedure is ended (S52) (when no DMA can be read out in step S47, there is no problem if there exists no DMA because the disk is new, but if every DMA in the disk is abnormal, for example, this recording processing is preferably canceled even if recording processing is instructed at this stage.)

On the other hand, if the read out content is not repaired completely, transition processing is carried out and that is, after the DMA is recorded by changing a write position, its position information is recorded into the DMA manager and then, the DMA repair processing is ended (S53). If any DMA can be read out in step S47 or there exists no DMA which cannot be read out in step S50, the procedure is ended without any DMA repair processing.

As a consequence, there is provided a disk device and disk processing method in which the DMA repair processing is executed in each operation indicated in FIGS. 5 to 8 and even if any DMA block incapable of being reproduced due to drop in recording quality exists, the frequency of DMA transitions can be suppressed by automatically rewriting the DMA, so that improvements in recording life and reliability can be expected.

Alternation Processing

For reference, the alternation processing executed by a DMA whose reliability is improved as described above will be described briefly using a flow chart of FIG. 10. Data to be recorded in a defective area generated in a user area is recorded alternatively in the spare area SA (S71). Additionally, the head addresses of the alternation object (defect area) and alternation destination (specified area in the spare area SA) are registered in the secondly defect list (SDL) within the DMA. The DMA is disposed on the inner periphery and outer periphery of the information recording medium as shown in FIG. 1 and the same data is registered in the SDLs of both the DMAs. If information is registered in the SDL, the update counter of the SDL is incremented by +1 (S72). Since reproduction processing based on highly reliable DMA processing can be carried out, there can be provided a disk device and disk reproducing method having an excellent operation stability.

As described above, in the above-described disk device, if part of the DMA cannot be read out due to damage, stain or the like of the disk, other DMA which is read out successfully is automatically recorded in a DMA area which fails to be read out without receiving any command form the host controller so as to carry out the repair processing. As a result, the alternation processing using the DMA can be carried out securely and thus, highly reliable reproduction processing can be carried out. Further, even if a plurality of the DMA blocks incapable of being reproduced due to drop in recording quality exist, the frequency of DMA transitions can be suppressed by repeating such automatic repair processing to rewrite the DMA, thereby improving the recording service life and reliability.

After the DMA is repaired, reading test of the DMA is carried out after repair and if reading fails again here, preferably, the procedure proceeds to transition processing or the like for moving the DMA area.

Those skilled in art can carry out the present invention according to a variety of embodiments and further, those skilled in art can imagine a variety of modifications of these embodiments easily and can apply them to a variety of embodiments without any inventive power. Therefore the present invention extends within a wide range not inconsistent with the disclosed principle and novel features and is not restricted to the above-described embodiments.

What is claimed is:

1. A disk device comprising:
a reading portion which reads out from a disk having a rewritable area, a plurality of defect management areas and a plurality of position information areas indicating an optimum position used for reproduction in the plurality of the defect management areas;
a recording portion which records information in the rewritable area or the defect management area;
a reproducing portion which reproduces information read out by the reading portion and stored in the rewritable area based on given defect management information; and
a control portion which reads out a plurality of defect management information based on the plurality of the position information stored in the position information area and controls the reading portion and the recording portion so as to repair defect management information which fails to be read out corresponding to defect management information which is read out successfully.

2. The disk device according to claim 1, wherein the control portion carries out repair processing of the defect management information when the disk device is started.

3. The disk device according to claim 1, wherein the control portion carries out repair processing of the defect management information when the disk is inserted into the reading portion.

4. The disk device according to claim 1, wherein the control portion carries out repair processing of the defect management information when the disk device is in idle time.

5. The disk device according to claim 1, wherein the control portion carries out repair processing of the defect management information when the disk is discharged from the reading portion.

6. The disk device according to claim 1, wherein the control portion, if it fails to read information of the position information area, reads out information of the plurality of the defect management areas successively to acquire updated defect management information.

7. The disk device according to claim 1, wherein the control portion, after the defect management information which fails to be read out is repaired, reads out defect management information after repair again.

8. The disk device according to claim 1, wherein the control portion, after the defect management information which fails to be read out is repaired, reads out the defect management information after repair again and if the defect management information fails to be read out, controls to record the updated defect management information in an area different from the defect management area.

9. The disk device according to claim 8, wherein the control portion records the position information of the updated defect management information in the position information area.

10. The disk device according to claim 1, wherein the control portion, if the disk is HD DVD, which is formatted according to rewrite format, carries out the reading processing with the position information area acting as two managers and the defect management area acting as four pairs of DMAs.

11. A disk processing method comprising:
reading out a plurality of defect management information based on a plurality of position information stored in a position information area from a disk having a rewritable area, a plurality of defect management areas and a plurality of the position information areas indicating an optimum position used for reproduction in the plurality of the defect management areas; and
repairing defect management information which fails to be read out corresponding to defect management information which is read out successfully.

12. The disk processing method according to claim 11, wherein repair processing of the defect management information is carried out when the disk device is started for reading the disk.

13. The disk processing method according to claim 11, wherein repair processing of the defect management information is carried out when the disk is inserted into the reading portion.

14. The disk processing method according to claim 11, wherein repair processing of the defect management information is carried out when the disk device is in idle time for reading the disk.

15. The disk processing method according to claim 11, wherein repair processing of the defect management information is carried out when the disk is discharged from the disk reading portion for reading the disk.

16. The disk processing method according to claim 11, wherein if information of the position information area fails to be read out, updated defect management information is acquired by reading out information of the plurality of the defect management areas successively.

17. The disk processing method according to claim 11, wherein after the defect management information which fails to be read out is repaired, defect management information after repair is read out again.

18. The disk processing method according to claim 11, wherein after the defect management information which fails to be read out is repaired, the defect management information after repair is read out again and if the defect management information fails to be read out, the updated defect management information is controlled to be recorded in an area different from the defect management area.

19. The disk processing method according to claim 18, wherein the position information of the updated defect management information is recorded in the position information area.

20. The disk processing method according to claim 11, wherein if the disk is HD DVD, which is formatted according to rewrite format, the reading processing is carried out with the position information area acting as two managers and the defect management area acting as four pairs of DMAs.
